(19) United States
(12) Patent Application Publication
(10) Pub. No.: US 2013/0095248 A1
(43) Pub. Date: Apr. 18, 2013

(54) PAINTING INSTALLATION FOR COATING OR PAINTING AN ELONGATED WORKPIECE

(71) Applicant: ABB AG, Mannheim (DE)

(72) Inventors: Thorsten WALDORF, Bad Nauheim (DE); Henning KÖLLNER, Florsheim am Main (DE)

(73) Assignee: ABB AG, Mannheim (DE)

(21) Appl. No.: 13/710,879

(22) Filed: Dec. 11, 2012

Related U.S. Application Data
(63) Continuation of application No. PCT/EP2011/002835, filed on Jun. 9, 2011.

(30) Foreign Application Priority Data
Jun. 12, 2010 (DE) 102010023578.4

(51) Int. Cl. B05C 9/12

(52) U.S. Cl. CPC B05C 9/12
USPC 427/372.2; 118/58; 118/642

(57) ABSTRACT

A painting installation for coating (e.g., painting) a workpiece, such as an elongated workpiece is disclosed. The installation and/or workpiece can be subdivided into a number of segments of a predetermined length. The painting installation can have three zones arranged next to one another and demarcated from one another. A stationary painting cubicle which has at least one painting robot, an adjoining flashing-off zone and an adjoining dryer, each being at least of the length L. The installation can also include at least one holder for transporting the workpiece along a running rail such that the individual segments successively run step by step through the individual zones.

### RELATED APPLICATION(S)

This application claims priority as a continuation application under 35 U.S.C. §120 to PCT/EP2011/002835, which was filed as an International Application on Jun. 9, 2011 designating the U.S., and which claims priority to German Application 10 2010 023 578.4 filed in Germany on Jun. 12, 2010. The entire contents of these applications are hereby incorporated by reference in their entireties.

### FIELD

The disclosure relates to a painting installation for coating or painting an elongated workpiece.

### BACKGROUND INFORMATION

To coat or paint an elongated workpiece, for example, a rotor blade of a wind turbine, a painting cubicle can be used, into which the elongated workpiece can be introduced. In such a case the painting cubicle is at the same time a flash-off zone and a dryer. In view of the circulating air and the heat energy, the energy efficiency of such a painting installation can be unfavorable. Furthermore, the cycle time can be relatively high and the output rate can be accordingly relatively low.

An arrangement for coating workpieces is known from DE 10 2008 011 998 A1, wherein at least one painting robot arranged on a running rail is movable along a running direction. The running rail is in turn movable relative to a stationary reference point parallel to a working surface. A painting device including two mutually opposed portal-like openings is provided, between which a working region is provided, wherein the painting cubicle is supported on at least two running gears arranged parallel to one another and is movable jointly therewith. The known arrangement can be suitable for coating a workpiece that is longer than the working region defined by the painting cubicle. The workpiece is coated sequentially, wherein the workpiece is subdivided into a plurality of axially adjacent portions and, to coat a respective portion, the painting cubicle is moved into a position in which the portion of the workpiece provided for coating is arranged in the working region and is thus surrounded by the painting cubicle and can be coated by means of the painting device.

### SUMMARY

A painting installation is disclosed for coating a workpiece which is subdivided into a plurality of segments of a predetermined length L, comprising: a painting installation having three zones which are arranged next to one another and are demarcated from one another, the three zones including a painting cubicle which has at least one painting robot, an adjoining flash-off zone, and an adjoining dryer, wherein the painting cubicle, the flash-off zone and the dryer each is at least the predetermined length L; and at least one holder for transporting a workpiece along a running rail in which individual segments pass successively step-by-step through the three zones.

A method of coating an elongated workpiece is disclosed which is subdivided into a plurality of segments of a predetermined length, comprising: introducing a first segment of an elongated workpiece having a plurality of segments into a painting cubicle of a painting installation, the painting installation having three zones which are arranged next to one another and are demarcated from one another, the three zones including the painting cubicle, an adjoining flash-off zone, and an adjoining dryer, wherein the painting cubicle, the adjoining flash-off zone, and the adjoining dryer each is at least the predetermined length L; coating the first segment of the elongated workpiece in the painting cubicle; simultaneously introducing the coated first segment of the elongated workpiece into the adjoining flash-off zone, and a second segment of the elongated workpiece into the painting cubicle; coating the second segment of the elongated workpiece in the painting cubicle; simultaneously introducing the first segment into the adjoining dryer, the coated second segment of the elongated workpiece into the adjoining flash-off zone, and a third segment of the elongated workpiece into the painting cubicle; and continuing to introduce each of the plurality of segments of the elongated workpiece through each of the three zones of the paint installation until each of the plurality of segments has successively been introduced into each of the three zones.

### BRIEF DESCRIPTION OF THE DRAWINGS

The disclosure will be explained hereinafter on the basis of the exemplary embodiments illustrated in the drawings, in which:

FIG. 1 shows a side view of an exemplary painting installation for coating an elongated workpiece,

FIG. 2 shows a front view of an exemplary painting installation for coating an elongated workpiece,

FIG. 3 shows an elongated workpiece to be coated, and

FIGS. 4-10 show individual process steps for coating the elongated workpiece.

### DETAILED DESCRIPTION

An exemplary painting installation is disclosed which can, for example, be optimized for coating or painting an elongated workpiece.

In accordance with the disclosure, a painting installation for coating or painting an elongated workpiece is disclosed, which is subdivided into a plurality of segments of a predetermined length L, wherein the painting installation has three zones which are arranged next to one another and are demarcated from one another. In accordance with an embodiment, a stationary painting cubicle, which has at least one painting robot, an adjoining flash-off zone and an adjoining dryer, wherein the painting cubicle, the flash-off zone and the dryer each are at least the length L, wherein at least one holder transports the workpiece along a running rail in such a way that the individual segments pass successively step-by-step through the individual zones.

In accordance with an exemplary embodiment, for example, energy savings of up to 80% can occur, based on the circulated air and heat energy used. Furthermore, the output rate is increased by reducing the cycle time.

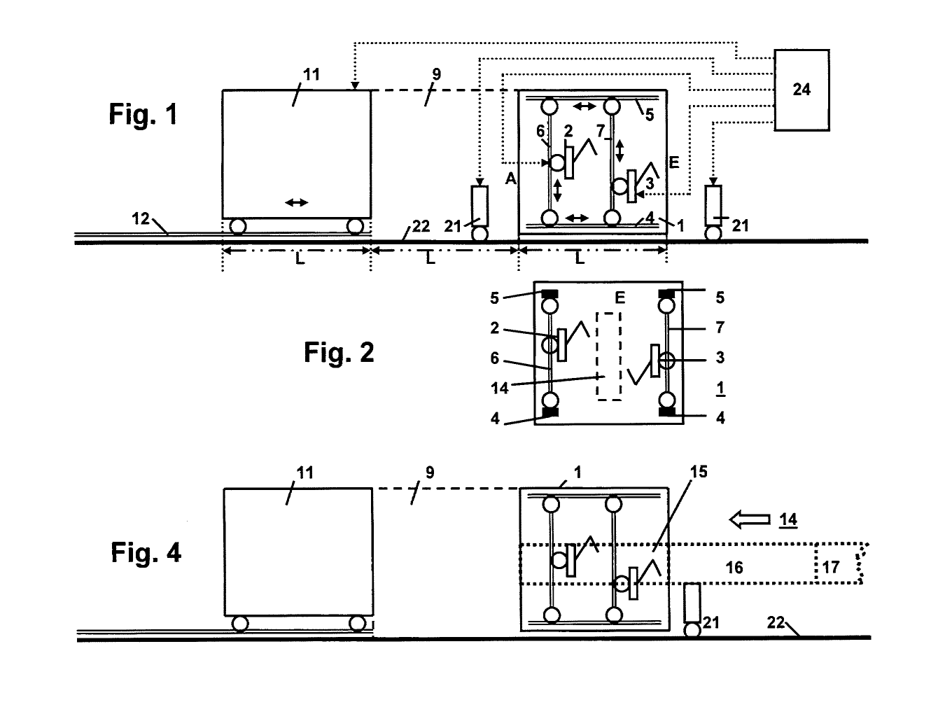

A side view of a painting installation for coating an elongated workpiece is illustrated in FIG. 1. A stationary painting cubicle 1 can be seen, in which at least one painting robot is arranged. Two painting robots 2 and 3 of this type are provided in the exemplary embodiment shown. For example, each painting robot 2, 3 can be movable both horizontally and vertically within predetermined limits via its robot base, to which end first (lower) horizontal running rails 4, second (upper) horizontal running rails 5, first vertical running rails 6 and second vertical running rails 7 are mounted within the painting cubicle 1. The first painting robot 2 is thus movable vertically along the running rail 6 and horizontally along the running rails 4, 5. The second painting robot 3 is movable vertically along the running rail 7 and horizontally along the running rails 4, 5. For example, the horizontal running axis is therefore combined with a vertical running axis.

The painting cubicle 1 has an inlet E for the entry of a workpiece to be coated and an opposed outlet A for the exit of the coated workpiece. The length of the painting cubicle 1 between the inlet E and the outlet A is L. A flash-off zone 9 adjoins the outlet A of the painting cubicle 1 and is likewise at least the length L. An autonomous dryer 11, such as an infrared dryer, is arranged after the flash-off zone 9 and is likewise at least the length L. The dryer 9 is movable along a horizontal running rail 12 within predetermined limits.

A plurality of holders 21 are provided to support and hold a workpiece to be transported into the painting cubicle 1 and are movable along a running rail 22 on the base side.

A control or regulation device 24 can be provided to control the painting robots 2, 3, the dryer 11 and the holders 21 supporting the workpiece and generates control signals for these structural components and forwards these signals on to the components.

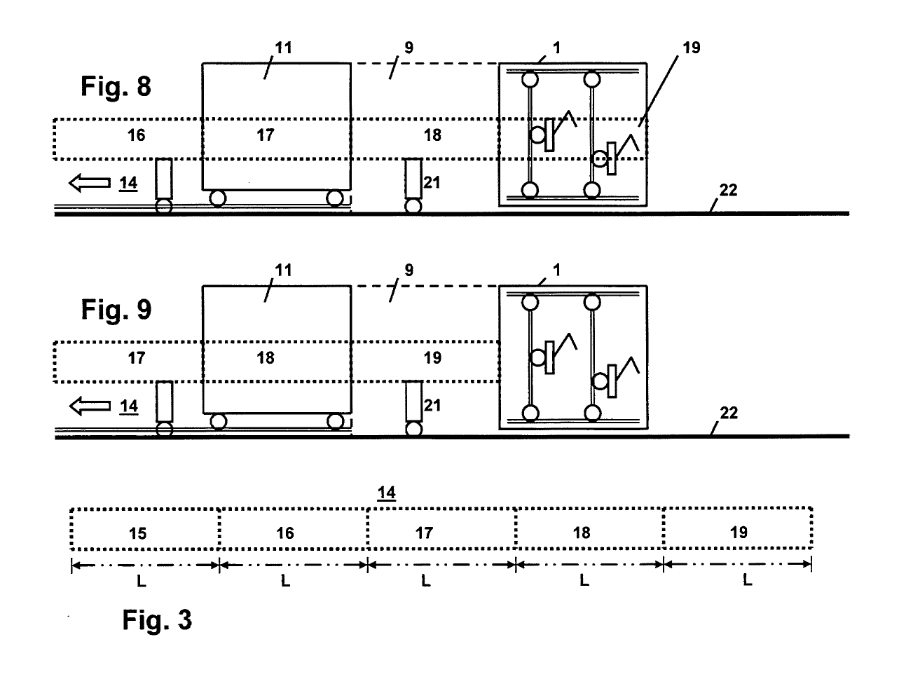

A front view of a painting installation for coating an elongated workpiece is illustrated in FIG. 2. The inlet E of the painting cubicle 1 can be seen, wherein the painting robot 2 is arranged in the left region of the interior of the painting cubicle 1 and is movable vertically along the running rail 6 and horizontally along the running rails 4, 5 in the direction between the inlet E and the outlet A and vice versa. The painting robot 3 is arranged in the right-hand region of the interior of the painting cubicle 1 and is movable vertically along the running rail 7 and horizontally along the running rails 4, 5 in the direction between the inlet E and the outlet A and vice versa. For example, one is able by means for coating, such as the two painting robots 2, 3, to coat, (e.g., paint), on all sides an elongated workpiece 14 introduced centrally into the inlet A of the painting cubicle 1 and extending in the direction toward the outlet A.

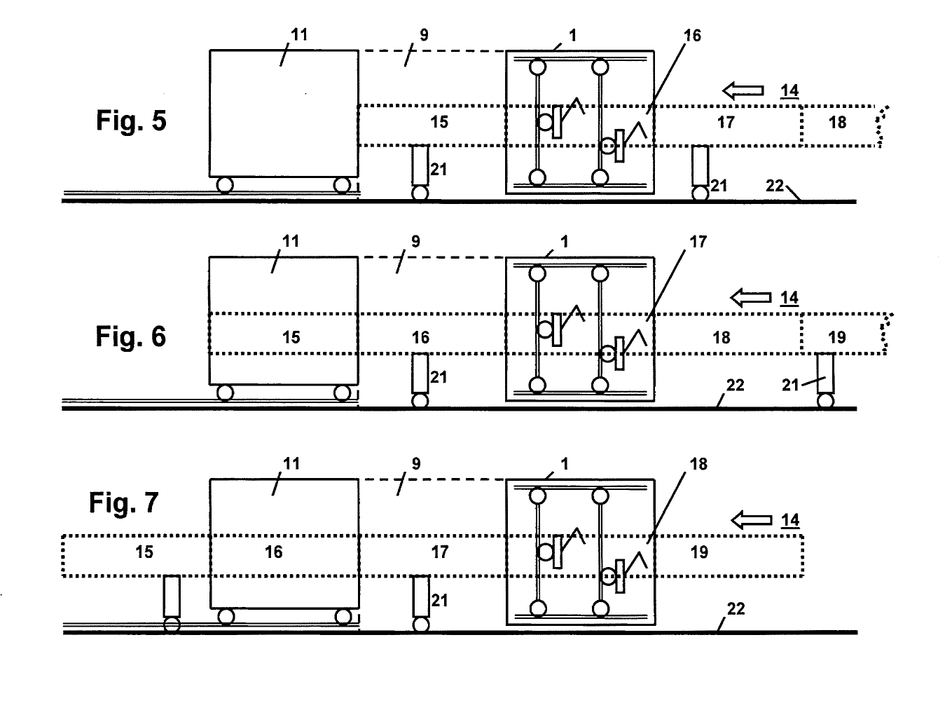

An elongated workpiece to be coated, for example a rotor blade of a wind turbine, is illustrated in FIG. 3. For the coating operation, the elongated workpiece 14 is subdivided into a plurality of segments, for example into a first segment 15, a second segment 16, a third segment 17, a fourth segment 18, a fifth segment 19, etc. The length of each segment 15, 16, 17, 18, 19 corresponds to the length L of the painting cubicle 1 between the inlet E and the outlet A.

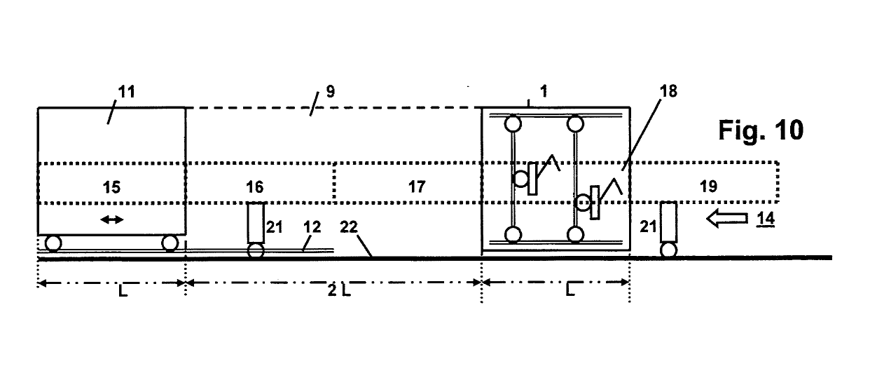

Individual exemplary steps of the process for coating the elongated workpiece are illustrated in FIGS. 4 to 9. The step-by-step direction of movement of the workpiece 14 is denoted by an arrow:

In accordance with FIG. 4, the first segment 15 of the workpiece 14 has been introduced completely into the painting cubicle 1 by means of the holders 21 movable along the running rail 22 and is coated/painted with use of the painting robots 2, 3. Once the coating operation is complete, the painting robots move back into their starting position and the workpiece 14 is simultaneously transported in the direction of movement shown, so that the second segment 16 of the workpiece is now introduced completely into the painting cubicle 1.

In accordance with FIG. 5, the second segment 16 of the workpiece 14 has been introduced completely into the painting cubicle 1 by means for holding such as the holders 21 movable along the running rail 22, and is coated/painted with use of the painting robots 2, 3. At the same time, the first segment 15 of the workpiece is located completely in the flash-off zone 9 and can flash off. Once the coating operation is complete, the workpiece 14 is transported in the direction of movement shown, so that the third segment 17 of the workpiece is now introduced completely into the painting cubicle 1.

In accordance with FIG. 6, the third segment 17 of the workpiece 14 has been introduced completely into the painting cubicle 1 by means of the holders 21 movable along the running rail 22 and is coated/painted with use of the painting robots 2, 3. At the same time, the second segment 16 of the workpiece is located completely in the flash-off zone 9 and can flash off. The first segment 15 is located in the autonomous dryer 11 and can dry. Once the coating operation is complete, the workpiece 14 can be transported in the direction of movement shown, so that the fourth segment 18 of the workpiece is now introduced completely into the painting cubicle 1.

In accordance with FIG. 7, the fourth segment 18 of the workpiece 14 has been introduced completely into the painting cubicle 1 by the holders 21 movable along the running rail 22 and is coated/painted with use of the painting robots 2, 3. At the same time, the third segment 17 of the workpiece is located completely in the flash-off zone 9 and can flash off. The second segment 16 of the workpiece is located in the dryer 11 and can dry. Once the coating operation is complete, the workpiece 14 is transported in the direction of movement shown, so that the fifth segment 19 of the workpiece is now introduced completely into the painting cubicle

In accordance with FIG. 8, the fifth segment 19 of the workpiece 14 has been introduced completely into the painting cubicle 1 by the holders 21 movable along the running rail 22 and is coated/painted with use of the painting robots 2, 3. At the same time, the fourth segment 18 of the workpiece is located completely in the flash-off zone 9 and can flash off. The third segment 17 of the workpiece is located in the dryer 11 and can dry. Once the coating operation is complete, the workpiece 14 can be transported in the direction of movement shown, so that the fifth segment 19 of the workpiece is now removed completely from the painting cubicle 1.

In accordance with FIG. 9, the fifth segment 19 of the workpiece is located completely in the flash-off zone 9 and can flash off. The fourth segment 18 is located in the dryer 11 and can dry. In the next (seventh) process step, the fifth segment 19 is introduced completely into the dryer 11. The workpiece 14 passes through the painting installation until all of its segments have passed through all process steps “coating or painting+flash off+drying” and have thus been provided with a layer of paint and have been dried.

In accordance with another exemplary embodiment, in contrast to the sequence of the individual process steps as explained above, the drying time of a segment of the workpiece can be extended in the dryer 11, since the autonomous dryer 11 “accompanies” a segment to be dried as the workpiece 14 is transported. For example, FIG. 10 shows an example which adjoins the process step according to FIG. 6. If FIGS. 7 and 10 are compared it can be seen that the segment 15 is subjected to an extended drying time, since the dryer 11 is moved along its running rail 12 additionally by a further length L of a segment.

In accordance with an embodiment, if the workpiece is moved further and the drying time of a segment of the workpiece 14 located in the dryer is not yet fully complete, the dryer 11 thus follows the corresponding segment. If the segment has been dried sufficiently, the dryer 11 thus travels to the next segment to be dried, independently of the rest of the process.

In accordance with an exemplary embodiment, the workpiece 14 is painted, flashed off and dried in segments. In accordance with another exemplary embodiment, the workpiece is moved further in a plurality of individual steps, wherein it is only painted when at a standstill. The painting cubicle 1 itself is not moved. In accordance with an exemplary embodiment, at least one horizontal running rail 4, 5 is used within the painting cubicle 11 to expand the horizontal working region in which painting can be carried out when the workpiece 14 is at a standstill. Thus, for example, the horizontal painting region is not only limited to the reach of the painting robot. In addition, at least one vertical running rail 6, 7 is used within the painting machine, which can expand the vertical working range of the painting robot, for example, to reach the upper and the lower position of a robot blade.

Thus, it will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

### LIST OF REFERENCE SIGNS

1 stationary painting cubicle
2 first painting robot
3 second painting robot
4 first (lower) horizontal running rail(s)
5 second (upper) horizontal running rail(s)
6 first vertical running rail(s)
7 second vertical running rail(s)
9 flash-off zone
11 autonomous dryer (infrared dryer)
12 horizontal running rail
14 workpiece (rotor blade)
15 first segment of the workpiece
16 second segment of the workpiece
17 third segment of the workpiece
18 fourth segment of the workpiece
19 fifth segment of the workpiece
21 holder for the workpiece
22 running rail
24 control/regulation device
A outlet of the painting cubicle
E inlet of the painting cubicle
L length of the painting cubicle between the inlet E and the outlet A=length of the individual segments of the workpiece 14

What is claimed is:

1. A painting installation for coating a workpiece which is subdivided into a plurality of segments of a predetermined length L, comprising:
a painting installation having three zones which are arranged next to one another and are demarcated from one another, the three zones including a painting cubicle which has at least one painting robot, an adjoining flash-off zone, and an adjoining dryer, wherein the painting cubicle, the flash-off zone and the dryer each is at least the predetermined length L; and
at least one holder for transporting a workpiece along a running rail in which individual segments pass successively step-by-step through the three zones.

2. The painting installation of claim 1, comprising:
at least one horizontal running rail for horizontal movement of the painting robot within the painting cubicle.

3. The painting installation of claim 1, comprising:
at least one vertical running rail for vertical movement of the painting robot within the painting cubicle.

4. The painting installation of claim 1, wherein the at least one painting robot is two painting robots for painting each side of an elongated workpiece independently.

5. The painting installation of claim 1, wherein the dryer is movable autonomously along a horizontal running rail.

6. The painting installation of claim 1, wherein the painting cubicle is stationary.

7. The painting installation of claim 1, wherein the painting cubicle, the flash-off zone and the dryer are of equal predetermined length.

8. The painting installation of claim 1, wherein the painting cubicle and the flash-off zone are of an equal predetermined length and a predetermined length of the dryer is greater than the predetermined length of the painting cubicle and the flash-off zone, to produce an extended drying time.

9. The painting installation of claim 1, wherein the dryer is an infrared dryer.

10. The painting installation of claim 1, wherein the at least one painting robot comprises:
at least two painting robots, each of the at least two painting robots being moveable in both a horizontal direction and a vertical direction.

11. A painting installation of claim 2, wherein the painting cubicle is stationary.

12. The painting installation of claim 6, comprising:
at least one horizontal running rail for horizontal movement of the painting robot within the painting cubicle.

13. The painting installation of claim 6, comprising:
at least one vertical running rail for vertical movement of the painting robot within the painting cubicle.

14. The painting installation of claim 6, wherein the at least one painting robot is two painting robots for painting each side of an elongated workpiece independently.

15. The painting installation of claim 11, wherein the dryer is movable autonomously along a horizontal running rail.

16. A method of coating an elongated workpiece which is subdivided into a plurality of segments of a predetermined length, comprising:
introducing a first segment of an elongated workpiece having a plurality of segments into a painting cubicle of a painting installation, the painting installation having three zones which are arranged next to one another and are demarcated from one another, the three zones including the painting cubicle, an adjoining flash-off zone, and an adjoining dryer, wherein the painting cubicle, the adjoining flash-off zone, and the adjoining dryer each is at least the predetermined length L;
coating the first segment of the elongated workpiece in the painting cubicle;
simultaneously introducing the coated first segment of the elongated workpiece into the adjoining flash-off zone, and a second segment of the elongated workpiece into the painting cubicle;
coating the second segment of the elongated workpiece in the painting cubicle; simultaneously introducing the first segment into the adjoining dryer, the coated second segment of the elongated workpiece into the adjoining flash-off zone, and a third segment of the elongated workpiece into the painting cubicle; and
continuing to introduce each of the plurality of segments of the elongated workpiece through each of the three zones of the paint installation until each of the plurality of segments has successively been introduced into each of the three zones.

17. The method of claim 16, comprising:
introducing each of the plurality of segments of the elongated workpiece by a holder, which is movable along a running rail.

18. The method of claim 17, comprising:
coating each of the plurality of segments of the elongated workpiece with at least one painting robot.

19. The method of claim 18, comprising:
moving the at least one painting robot back to a starting position and simultaneously transporting the elongated workpiece along the running rail once the coating of a segment of the plurality of segments of the elongated workpiece has been completed.

20. The method of claim 18, wherein the at least one painting robot includes at least two painting robots, the method comprising:
moving each of the at least two painting robots in both a horizontal direction and a vertical direction.
